(19) United States
(12) Patent Application Publication
(10) Pub. No.: US 2017/0079758 A1
(43) Pub. Date: Mar. 23, 2017

(54) Carbon Coated Filament Cord

(71) Applicant: Christine Cooper, Springfield, VA (US)

(72) Inventor: Christine Cooper, Springfield, VA (US)

(21) Appl. No.: 15/198,519

(22) Filed: Jun. 30, 2016

Related U.S. Application Data
(60) Provisional application No. 62/219,726, filed on Sep. 17, 2015.

(51) Int. Cl. A61C 19/05; A61C 13/00

(52) U.S. Cl. CPC A61C 19/052; A61C 13/0024

(57) ABSTRACT

A carbon coated filament cord for marking the sidewall of dental prostheses. The carbon coated filament cord is made up of a strand of filaments having a core and a marking coating placed around a circumference of the core along the length of the strand of filaments. The diameter of both the core and the marking coating is sized to fit within an interproximal spacing between teeth and dental prostheses such as crowns, bridges or onlays. When pressure is applied to the strand from the tooth and adjacent prosthesis, an easily identifiable mark is left on the sidewall of the prosthesis at that position, allowing a dental professional to easily locate the area that requires further work.

### CROSS REFERENCE TO RELATED APPLICATIONS

This application claims the benefit of U.S. Provisional Application No. 62/219,726 filed on Sep. 17, 2015. The above identified patent application is herein incorporated by reference in its entirety to provide continuity of disclosure.

### BACKGROUND OF THE INVENTION

The present invention relates to dental marking materials. More specifically, the present invention related to dental marking materials that are configured to leave a temporary mark on teeth and dental prostheses to easily identify undesirable interproximal spacing within a patient's mouth.

Dentists and other dental professionals often need to install crowns, bridges, onlays and other dental prosthesis when providing dental care to a patient. It is crucial for both a patient's oral comfort as well as their long term dental health that the prostheses be properly spaced between other teeth within the mouth. An interproximal space that is too wide will repeatedly attract larger morsels of food that can become lodged between the teeth while one that is too tight can make it difficult to dislodge and remove smaller deposits. While certain methods currently exist in the prior art to ensure that a new crown or bridge is properly shaped on the occlusal, or top, surface of the prosthesis, these methods are difficult to implements in the interproximal spaces between teeth. For example, articulating paper provides a very thin strip of material with a coating of carbon that can placed in the mouth of a patient. The patient bites down and grinds slightly on the paper, causing the carbon layer from the articulating paper to leave a mark on the high spots of the teeth, which a dentist can then shape accordingly. However, these thin strips are not easily placed between teeth, and when they are placed therein, it can be cumbersome to apply the required pressure at the right position to leave a mark that is useful. Therefore, there is a need in the prior art for a device that is capable of easily marking the interproximal sides of teeth and dental prostheses to indicate to a dental care professional where extra material needs to be removed.

### SUMMARY OF THE INVENTION

In view of the foregoing disadvantages inherent in the known types of dental marking materials now present in the prior art, the present invention provides a carbon coated filament cord wherein the same can be utilized for providing convenience for the user when identifying undesirable spacing within a patient's mouth. The present invention comprises a strand of filaments having a core and a marking coating disposed around the circumference of the core along the length of the strand of fiber. The diameter of both the core and the marking coating is sized to fit within an interproximal spacing between present teeth and dental prostheses such as crowns, bridges or onlays. When pressure is applied to the strand from the tooth and adjacent prosthesis, an easily identifiable mark is left on the sidewall of the prosthesis at that position, allowing a dental professional to locate the area that requires further work.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a perspective view of the carbon coated filament cord.

FIG. 1B shows a cross sectional view of the carbon coated filament cord.

FIG. 2 shows a perspective view of the carbon coated filament cord placed in between a tooth and a crown.

FIG. 3 shows a perspective view of a dental crown with a mark made from the carbon coated filament cord.

### DETAILED DESCRIPTION OF THE INVENTION

Reference is made herein to the attached drawings. Like reference numerals are used throughout the drawings to depict like or similar elements of the carbon coated filament cord. The figures are intended for representative purposes only and should not be considered to be limiting in any respect.

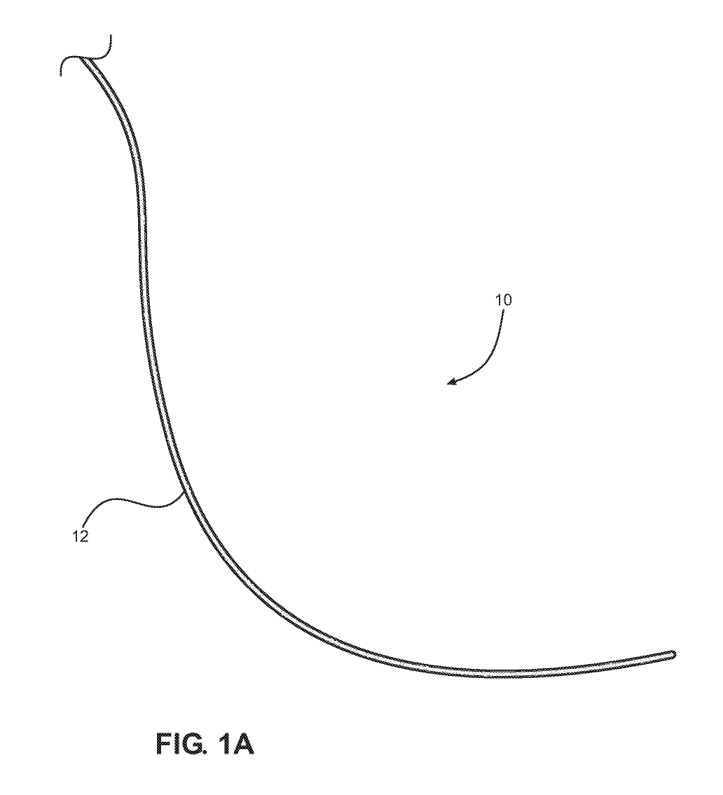

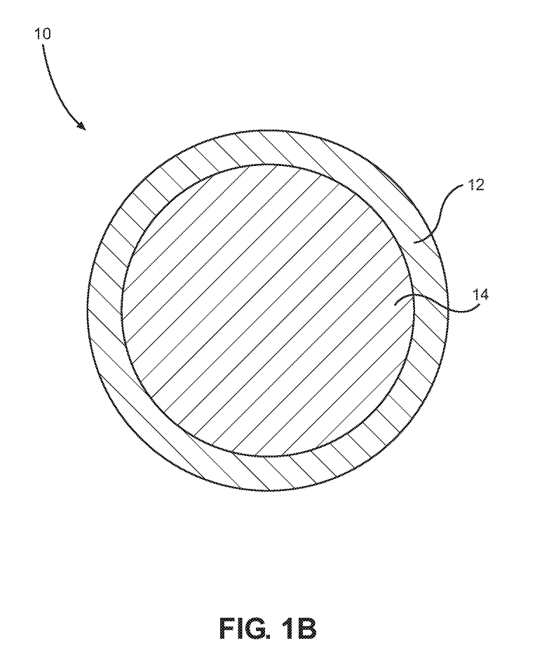

Referring now to FIGS. 1A and 1B, there are shown a perspective view and a cross sectional view of the carbon coated filament cord, respectively. The carbon coated filament cord 10 comprises a strand of filaments having a core 14 and a marking composition 12 disposed thereon. The marking composition 12 is evenly distributed along the length of the strand of filaments and covers the entire circumference thereof. In one embodiment of the carbon coated filament cord 10, the core 14 is composed of a twist or braid from a synthetic polymer such as nylon and the marking composition 12 is a layer of carbon powder resting thereon. In some embodiments, the marking composition 12 includes a coloring agent, such as a dye, to allow for easy identification of the position of a marking made on a dental surface. The diameter of the combined core 14 and marking composition 12 is such that it can be placed within an interproximal space in a patient's mouth.

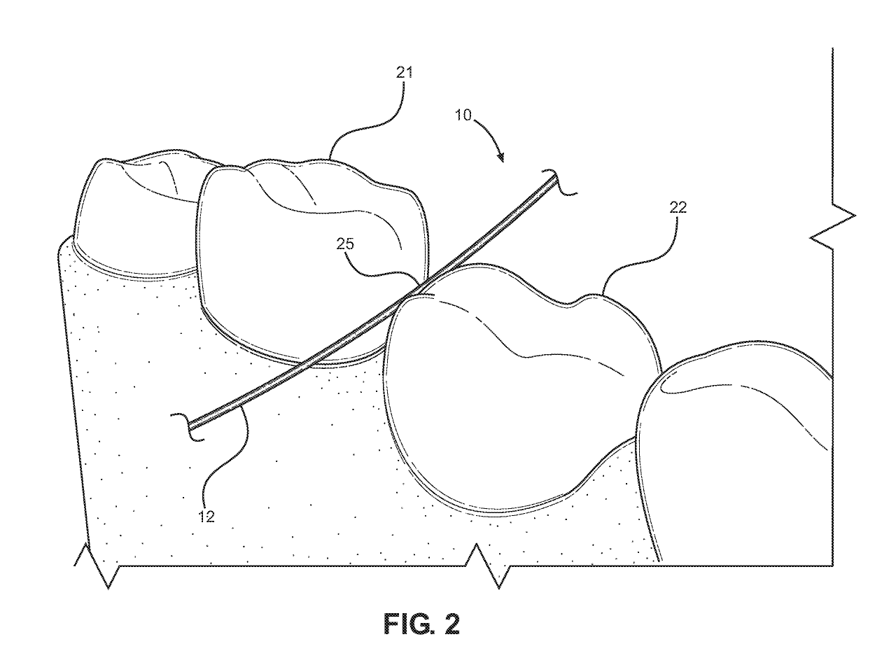

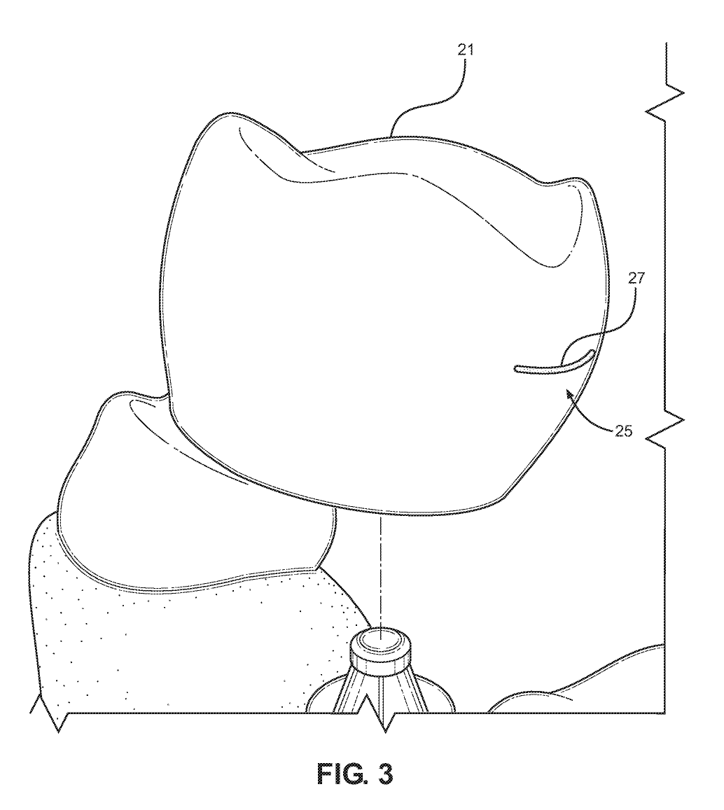

Referring now to FIGS. 2 and 3, there are shown perspective views of the carbon coated filament cord placed in use. The carbon coated filament cord 10 is placed between two dental elements, such as two dental prostheses or a tooth 22 and a crown 21. The carbon coated filament cord 10 is pushed until it reaches the gum line of the patient. The strand is then pulled back and forth while being slowly lifted from the gum line. As the strand is lifted, the strand leaves a marking 27 on the adjacent teeth or dental prostheses when the interproximal space is less than or equal to the diameter of the strand. When the interproximal space is less than or equal to the diameter of the strand, the sides of the adjacent teeth or dental prostheses exert pressure on the strand, removing a portion of the coating from the strand as a marking 27 on the dental crown 25. A dental professional can then easily work with and sculpt the crown 25 as required with the help of the marking 27.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A filament cord, comprising a strand of filaments including a marking composition disposed evenly thereon, covering the length to the filament cord.

2) The carbon coated filament cord of claim 1, wherein the strand of filaments comprises a nylon core.

3) The carbon coated filament cord of claim 1, wherein the marking composition is powdered carbon.

4) The carbon coated filament cord of claim 3, wherein the powdered carbon is dyed with a coloring agent.

5) A method of marking dental prostheses, comprising the steps of:
placing a carbon coated filament strand within an interproximal spacing between adjacent dental elements, the filament strand comprising a marking composition disposed evenly along a length thereof;
lifting the carbon coated filament strand through the interproximal spacing such that pressure created by sidewalls of the adjacent dental elements causes a marking to be left on the adjacent dental elements when the interproximal spacing is less than or equal to a diameter of the carbon coated filament strand.

6) The method of marking dental prostheses of claim 5, further comprising the step of pulling the carbon coated filament strand back and forth while it is being lifting.
